(19) United States
(12) Patent Application Publication
(10) Pub. No.: US 2017/0228801 A1
(43) Pub. Date: Aug. 10, 2017

(54) METHOD OF CHARITABLE GIVING

(71) Applicant: Careicon IP Ltd., Preston (GB)

(72) Inventors: Steven Jackson, Preston (GB); Grant Micheal Briston, Preston (GB); Edward Hibrert, Preston (GB); Matthew Lishman, Preston (GB); Peter Riddell, Preston (GB)

(21) Appl. No.: 15/495,818

(22) Filed: Apr. 24, 2017

Related U.S. Application Data
(63) Continuation-in-part of application No. 14/473,642, filed on Aug. 29, 2014, now abandoned.

(51) Int. Cl. G06Q 30/02; G06Q 50/00

(52) U.S. Cl. CPC G06Q 30/0279; G06Q 50/01

(57) ABSTRACT

A charitable giving method is disclosed that uses a social media platform to bring together individuals, businesses, and charitable causes. The use of the social media platform incentivizes individuals and businesses to increase their financial support to charitable causes. The individuals register certain demographic and psychographic information on the social media platform, and that information is used by the businesses and charitable causes in conjunction with directing charitable giving. The individuals and businesses gain recognition for their charitable donations through a visual representation on the charitable social media platform as well as on other social media platforms where the information is shared. The visual representation may be graphical symbols, numerical values of charitable impact, or name/pictures shown in lists displayed on the social profiles of the individuals or businesses that contribute or someone else's profile pages. The charitable causes receive an increase in donations and promotion of their charitable missions.

### CROSS-REFERENCE TO RELATED APPLICATION

The present application claims priority to, and is a continuation in part of, a co-pending United States patent application entitled “Method of Charitable Giving” having Ser. No. 14/473,642, filed on Aug. 29, 2014, which is entirely incorporated herein by reference.

### FIELD OF THE INVENTION

The present invention relates generally to a method for charitable giving and more particularly to a method of charitable giving that includes a social media platform where individuals, businesses, and charitable causes come together to garner and increase charitable support.

### BACKGROUND OF THE INVENTION

It is desirable for individuals and businesses to engage in charitable giving, and it is easier to get individuals and businesses to give financial support to charitable causes when the individuals and businesses are recognized. Social media has become a prominent way in which individuals communicate and where businesses and even charitable causes promote their organizations. Putting individuals, businesses, and charitable causes together on a social media platform aids in bringing these entities together and publicly recognizing charitable giving by individuals and businesses and the purposes and missions of the charitable causes.

The prior art shows some of the solutions that have been created to incentivize businesses and individuals to engage in charitable giving. None of the prior art solutions, however, integrate charitable giving, businesses, and individuals with a social media platform in the way of the current invention.

### SUMMARY OF THE INVENTION

As such, the present invention is directed to a method for providing public recognition to charitable giving by an individual and/or a business. The method incentivizes both individuals and businesses to provide financial support to charitable causes through public recognition. In addition, the businesses and charitable causes gain access to demographic and psychographic information of the individuals associated with the giving to better market products and charitable missions directly to these individuals. Furthermore, while some demographic information of a donating individual may be shared with the businesses, charitable causes, and other users associated with the giving, the privacy of the individual is protected by hiding the individual's true location on a geographical map.

The current invention comprises providing a social media platform for use on a computer network system wherein at least one individual, at least one charitable cause, and at least one business register information via the social media platform. In an embodiment of the social media platform, the individual provides financial support to the charitable cause via the social media platform, and the individual's financial support is shown on the social media platform via a visual representation. The visual representation of an individual can be graphical such as the charity's campaign logo, a symbol or a graphic element (such as a heart design) provided by the social media platform, the individual's profile picture with a specific graphic effect or filter (such as a dog face filter), the individual's profile picture with a graphic item superimposed on it, and so forth. Alternatively, the visual representation may be a list of supported charities, a count of charitable activities, and so on. Additionally, the visual representation may be displayed on the individual's social profile page and/or the page of a group the individual is associated with for a specific period, such as on the pages of the individual and the individual's high school classmates' group for 3 months.

Furthermore, the individual in this embodiment can view the charitable activity of other individuals also registered with the social media platform, and can also view his own charitable activity relative to that of the other individuals registered with the social media platform. This can inspire competitiveness within charitable giving. In addition to giving a donation or gift to a charitable cause, the charitable activity of an individual may include sharing/promoting a charitable cause on the social media platform, being identified as a referral or inspiration to other donors (e.g. when another user clicks a tracked link originated from the individual's posting and donates), accepting a gift donation, and so forth. For instance, the individual may see his own ranking concerning the amount of donations made to a charity and the other uses giving the most in a specific geographical area, such as worldwide, in his country, or even in his neighborhood, or in a certain time period, such as last year or this month. Another example would be a celebrity being a top donor to a charity simply by his sharing of the charity's campaign posting even though he does not make a big donation. This celebrity may be able to see other celebrities' influence relative to his in terms of causing other users to re-post his posting or donate.

In addition, a business registered with this embodiment may also provide financial support to the charitable cause as directed by the individual. This charitable contribution can be recognized via a visual recognition of the financial support in the form of the business's corporate logo superimposed on the charitable cause's logo on the social media platform. A charitable cause is allowed to maintain a presence on the social media platform and receive financial support from the individuals and businesses via the social media platform. The demographic and psychographic analytic information about the choices individuals have made are aggregated and the information is relayed to the business and the charitable cause. The business or charitable cause may thus use such information to improve its next campaign.

In another embodiment, the charitable activity of an individual and/or a business can be converted or tallied into accumulatible points, called CareCount^{SM}, in the social profile of the individual/business. Each charitable activity is assigned, by the embodiment, a weight based on the types of activity. For instance, a user's direct donation of $500-$599 may be given 50 points while directly or indirectly causing another use to donate $500 may be given 5 points. In this embodiment, the accumulated points of a user may be converted to a fiat currency, based on the implementations of the embodiment, for the user to purchase a gift donation from a registered business or donate directly to charitable causes. For instance, once the user accumulates 10,000 points, a credit of USD $100, GBP £80, or JPY ¥11,000, depending on the location of the user, would be added to his profile wallet. Alternatively, a business entity in this embodiment may accept points for trading gift donations and later be paid by the social media platform's operating entity with real money for the transactions. The points in the embodiment may expire after a certain period of time or never expire depending on the policy of the social media platform.

An alternate embodiment may additionally include leaderboard features for individual users, businesses, and charitable causes in the social media platform. In an embodiment with leaderboards, the leaderboard of a charity may show the top supporters (both businesses and users), overall or for a specific campaign, of the charity on the charity's social profile page. In this embodiment, the leaderboard on a user's profile may show the people who have donated to a specific charity because of, or through the action alerts of, the user. This feature may motivate users to donate more. For instance, a user may want to become a top supporter and be seen on the leaderboard a local charity's social profile so that people in his neighborhood would know his contribution. Another example would be a fan of a movie star who may click a tracked link to a charity in the star's posting and become a top supporter just to be seen on the movie star's leaderboard.

In another embodiment, the leaderboards may be geographical and show users within a certain area whom have participated the most in charitable activities along a visual radius, placed clockwise, to show those whom have supported charity the most. Such a geographical leaderboard may be shown as a computerized map that is interactive and can be moved around, zoomed in/out on, etc. This embodiment preferably incorporates an anonymizing technology which prevents the user's exact location being discovered. A preferred anonymizing technology randomly shifts the user's location along a virtual grid within the map ever so slightly—as well as limiting the zoom level of the map so as that it can't be zoomed in to show a single house. In an embodiment, the zoom-in threshold can be fixed or determined based on the population density of the specific area. For instance, if a fixed threshold in an embodiment is 600 m or 2000 ft., the map cannot be further zoomed in when the maximum distance between the borders of the shown area, either from east to west or from north to south, is at or below the threshold. In an embodiment where the zoom-in threshold is dynamic, the embodiment may use the population density of the geographic area to determine the threshold, such as 100 m or 330 ft. in a crowded urban area (with more than 3,000 people per square miles), 600 m or 2,000 ft in a less crowded suburban area (with 1,001˜2,999 people per square miles), and 1200 m or 4000 ft in a rural area (with no more than 1,000 people per square miles).

In an embodiment, a user may be able to “nudge” a business to start a sponsorship campaign (a gift) open to all charities by a simple click, or for a specific charity by selecting the charity in a “nudge” list. An alternate embodiment may further include gamification throughout the platform, which allow a user to earn items or points, if used with a point system, either from the platform itself or from participating businesses. The user of such embodiment may earn the items or points by achieving various goals, such as supporting 10 charities or purchasing 3 gift donations from the participating businesses to unlock an achievement (e.g. a Careie Achievement^{SM} in an embodiment). In this embodiment, once the items or points are earned, the platform or the participating businesses may give a corresponding donation to a charity, such as $1 for a quest accomplished, immediately or by a timed release, such as donating an accumulated amount once every month.

It is an object of the present invention to increase financial support to charitable causes through the use of a social media platform.

It is a further object of the invention to incentivize individuals to encourage others to support the charitable cause that they wish.

It is a further object of the invention to recognize businesses for their charitable support.

It is a further object of the invention to provide financial support and awareness to charitable causes.

It is a further object of the invention to provide businesses and charitable causes with promotional marketing.

It is a further object of the invention to provide demographic and psychographic information of interested individuals to businesses and charitable causes.

The novel features that are considered characteristic of the invention are set forth with particularity in the appended claims. The invention itself, however, both as to its structure and its operation together with the additional object and advantages thereof will best be understood from the following description of the preferred embodiment of the method for charitable giving. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows the functional blocks outlining a social media platform, an individual user entity, a business entity, and a charity entity of an embodiment.

FIG. 2A is a flowchart outlining the functions a user entity may perform on the social media platform of the embodiment.

FIG. 2B shows features that may be displayed on the user entity's social profile in the embodiment

FIG. 3A is a flowchart outlining the functions a business entity may perform on the social media platform of the embodiment.

FIG. 3B shows features that may be displayed on the business entity's social profile in the embodiment.

FIG. 3C shows the feedback a business entity of this embodiment may get.

FIG. 3D shows how an exemplary sponsorship or gift donation is created in this embodiment.

FIG. 4A is a flowchart outlining the functions a charity entity may perform on the social media platform of the embodiment.

FIG. 4B shows features that may be displayed on the charity entity's social profile in the embodiment.

FIGS. 5A-5F show a computerized map on a leaderboard with the profile pictures of top 10 supporters located in a circled geographical area in an embodiment.

### DESCRIPTION OF PREFERRED EMBODIMENTS

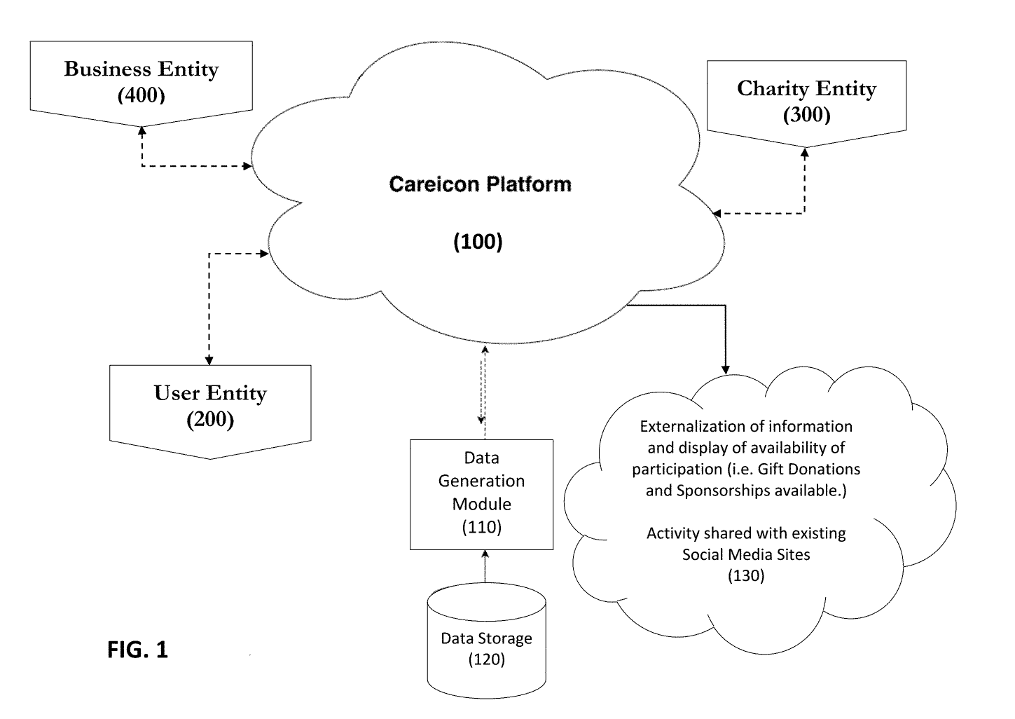

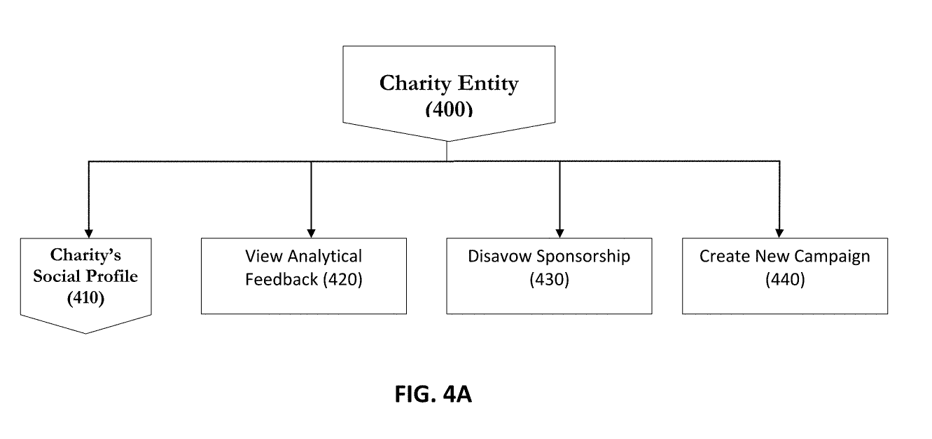

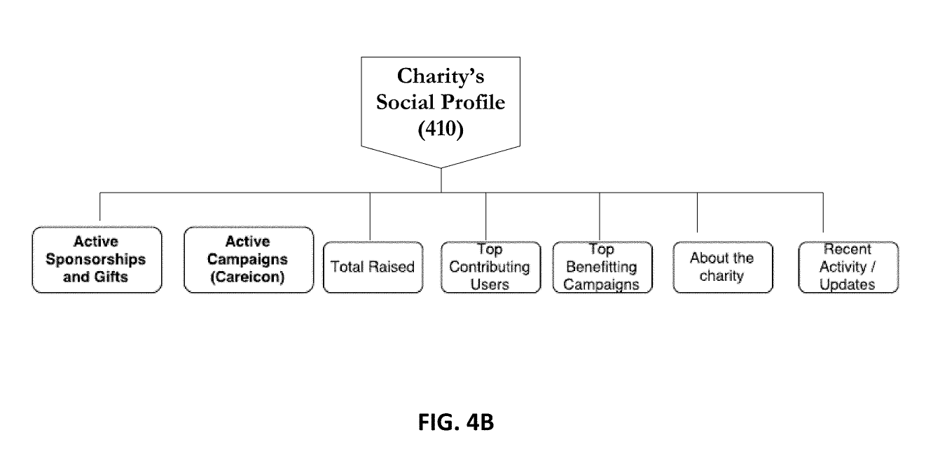

The present invention relates to a method for charitable giving. The preferred method of the invention includes a social media platform for charitable causes as shown in FIGS. 1-5. In this preferred embodiment, the social media platform, Careicon^{SM} Platform (100), is used in conjunction with a computer network system and allows individuals (User Entity 200), businesses (Business Entity 300), and charitable causes (Charity Entity 400) to come together to mutually provide benefits to all parties while increasing financial giving to charitable causes. The social media platform (100) can be used on any type of computing devices including, but not limited to, personal computers, tablets, mobile devices, and smart phones.

The individuals (200), businesses (300), and charitable causes (400) access the social media platform (100) and register with the platform (100). In order to register with the platform (100) in FIG. 1, the individuals (200), businesses (300), and charitable causes (400) are required to input certain information into a database (120) that is maintained with the social media platform (100) on a computer network system. Some of the information that is required includes demographic and psychographic information, location, gender, and age. In addition to these items, other information may be required depending on the goals of the social media platform provider and/or the individuals, businesses, and charitable causes. Once the individuals (200), businesses (300), and charitable causes (400) register with the social media platform (100), they each have their own personal social profile that other users of the social media platform (100) can view.

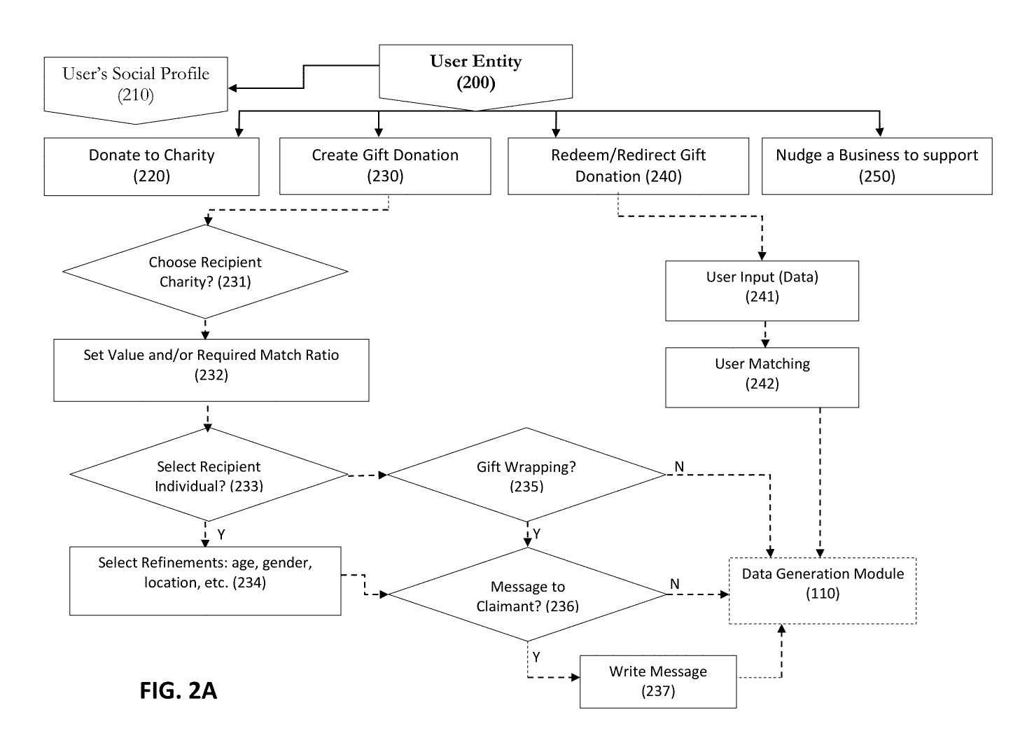

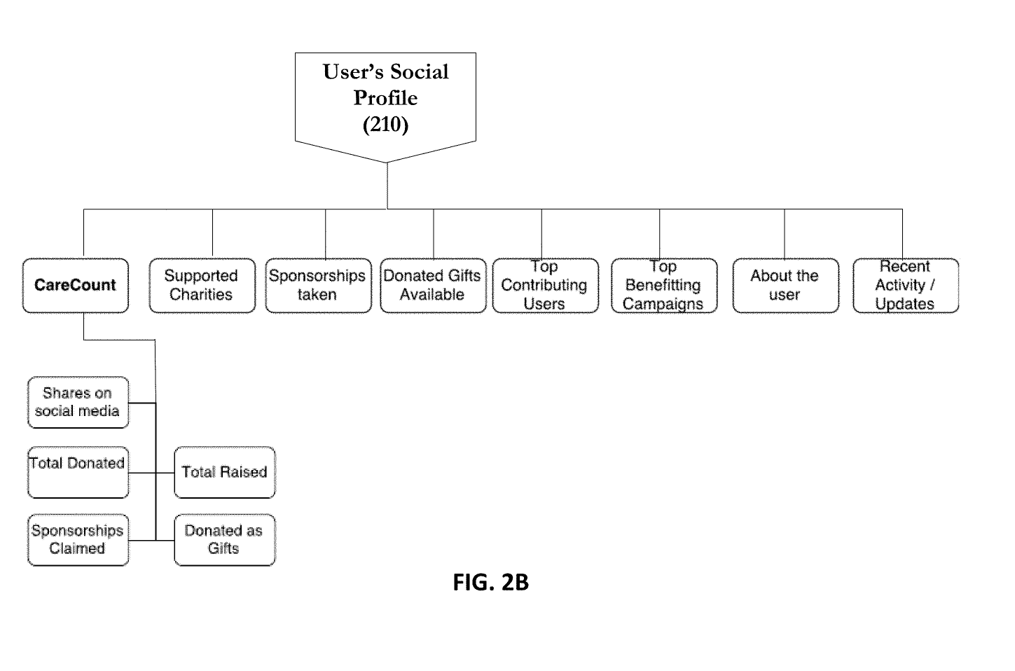

The social media platform (100) in FIG. 1 permits individual users (200) to provide financial support for charitable causes (400) (see, step 220 in FIG. 2A) and show their support via at least one visual representation on their personal social media profile. As shown in FIG. 2B, the exemplary visual representations may include a numerical value (CareCount^{SM}) which is a measurement of the individual's impact on the charities, such as sharing on social media, donations made, inspiration to other donors, etc., a list of the supported charities, sponsorships taken, gifts donated, and so forth. A CareCount^{SM} value can be the sum of the number of donations made, the numbers of postings/shares, the number of gifts given, etc., or the value can be a weighted sum where the individual's personal donations are given more weight than his shares.

This support can also be integrated with other social media platforms used by the individual and can show support of certain causes on the other social media platforms as well. Within the charitable social media platform (100), the individual can see the charitable activity, e.g. donating, sharing charitable content, receiving a gift donation, participating in a campaign, or “nudging” a business to support charities (see, e.g., FIG. 2A), of other users of the platform (100) as well as his own charitable activity relative to that of other individual users of the charitable social media platform (100).

The individuals (200) can also provide financial support to charitable causes (400) via a gift (see, steps 230-237 in FIG. 2A). This gift can be given to a specific individual or a group of individuals identified by demographic and psychographic factors of a receiving charity or individual (see, steps 233 & 234 in FIG. 2A). The gifts can be virtually wrapped from the giver based on occasion or other personal preferences (see, step 235 in FIG. 2A). Moreover, an individual (200) receiving a gift can accept it or can change it (see, step 240 in FIG. 2A). This gift can be modified by the individual (200) to suit his or her preferences. For example, the individual (200) can select a charitable cause different than the gift giver. This can be done subject to any conditions put on the gift by the charitable cause or the business. Furthermore, the platform (100) or the gift giver may require the receiving individual to provide some personal information in order to redeem the gift (see, step 241 in FIG. 2A) and/or match the gift to a specific charity (see, step 242 in FIG. 2A).

Additionally, the individuals (200) can rate the charitable causes (400) on the social media platform (100) and indicate their own personal level of support to the causes (400). In a gamified platform of an alternate embodiment, the individuals can also participate in quests or other activities (such as increasing the number of donations made or postings of charitable contents) that increase engagement with the social media platform and incentivize financial support to the charitable causes on the platform.

The individuals (200) using the social media platform (100) can perform standard social media actions such as posting status updates, linking to other individual users to see their updates, viewing a newsfeed, and viewing news items of geographical relevance to their own location. In addition, the individuals can share their activity on other social media platforms (see, e.g., step 130 in FIG. 1).

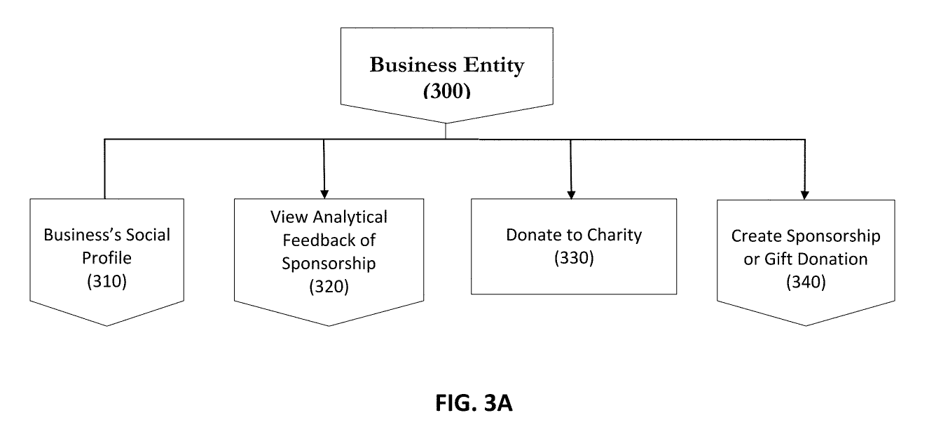

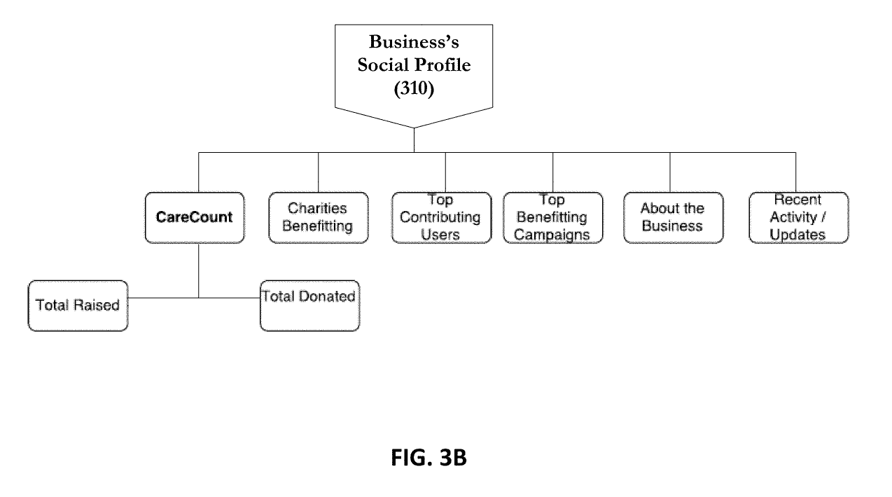

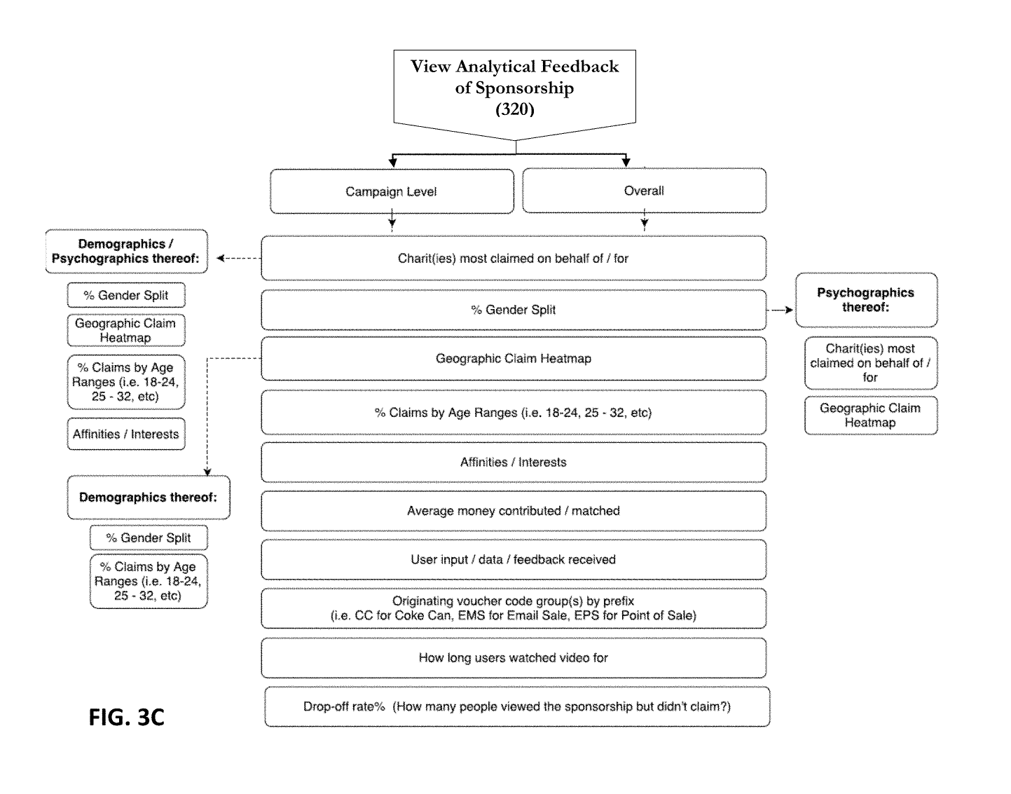

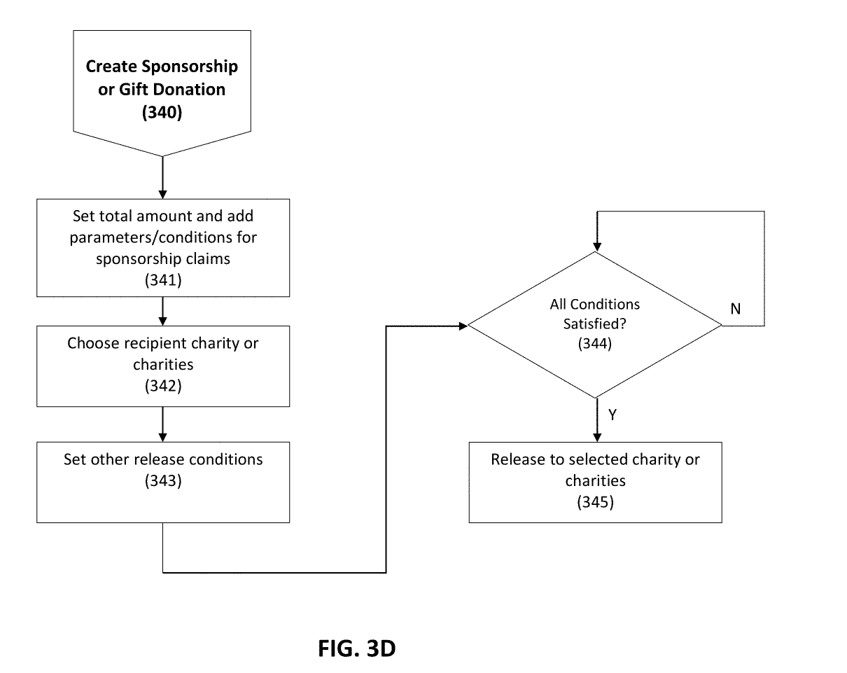

The businesses (300) that register with the social media platform (100) may provide financial support for the charitable causes (400) by themselves (see, step 330 in FIG. 3A) or directed according to the wishes of the individual platform users (200) (see, step 340 in FIG. 3A). In order to facilitate gift giving, the businesses (300 set up gifts as discussed above. These gifts are either restricted to a certain charitable cause or causes (400), or they are unrestricted. When the individual (200) accepts a gift from a business (300), the individual (200) selects the charitable cause (400) to which he wants the funds to be sent. The social media platform (100) tracks the funds due to each charitable cause (400) and enables the funds to be properly distributed. In exchange for allowing the individual users (200) to direct the financial support of the businesses (300), the businesses (300) may receive a visual recognition of the support visible on the social media platform (100). Exemplary visual recognitions include a business's corporate logo superimposed on the charitable cause's logo, a numerical value of the business's charitable impact (CareCount^{SM}), a list of charities benefiting from this business (300), and so on (see, e.g., FIG. 3B).

In addition, the businesses (300) in this embodiment may receive aggregated demographic and psychographic analytic information about the choices the individual users (200) of the social media platform (100) have made (see, e.g., FIG. 3C). This information is of value to the businesses in that it provides information relating to the tastes of the individuals allowing the businesses to better market their products and services. Psychographic information is the information that includes the demographic information provided by the individual coupled with the emotional information that is acted upon by the individual. This emotional information can include the physical location of the individual at the time of the donation (e.g. at a particular business, hospital, sporting event, etc.). It can also include information relating to TV or other media coverage of charitable causes that occur at the time the donation was made. The timing of holidays (e.g. Mother's Day, Christmas, Thanksgiving, etc.) and peer activity (e.g. whether the individual's social media connections are simultaneously donating) relative to the time a donation is made by an individual can also be captured as part of the emotional information gathered. These pieces of information can be used to identify the motivation that prompted a particular individual to donate at a certain time or place.

In this embodiment, the businesses (300) can offer contributions as gifts available to an individual (100) to direct to the charitable causes (400) of the individual's choice (see, e.g., FIG. 3D). These gifts can be subject to restrictions imposed by the business and/or the charitable cause (see, e.g., step 341 & 343 in FIG. 3B). These gifts can be made to require a matched donation thereby increasing the overall charitable support. The matched portion of the gift can be either a one to one match or some other type of varying ratio. For example, the business could offer $4.00 for every $1.00 offered by the individual or require the total amount to reach a certain figure, such as 1 million dollars to match the same amount. The gifts can be made available on an individual's demographic and psychographic basis that is based on the information that the individual uses (200) when registering on the social media platform (100), such as age, gender, location, interests, and supported charities. Other exemplary conditions include information provided by an individual user (200) such as a QR code on a receipt showing a purchase by the individual user (200), a promotional code printed on a voucher, a link-based voucher code (URL), an emailed-based voucher codes, and so forth.

The charitable causes (400) that register and use the social media platform (100) maintain a presence on the social media platform (100) and receive financial support from the individuals (200) and businesses (300) also registered and using the social media platform (100). The result of the use of the preferred social media platform (100) for charitable giving is to make charitable giving a more rewarding experience for the individuals (200), businesses (300), and charitable causes (400). This causes increased financial support flowing to the charitable causes (400) while at the same time adding a benefit to the individual (200) and the business (300).

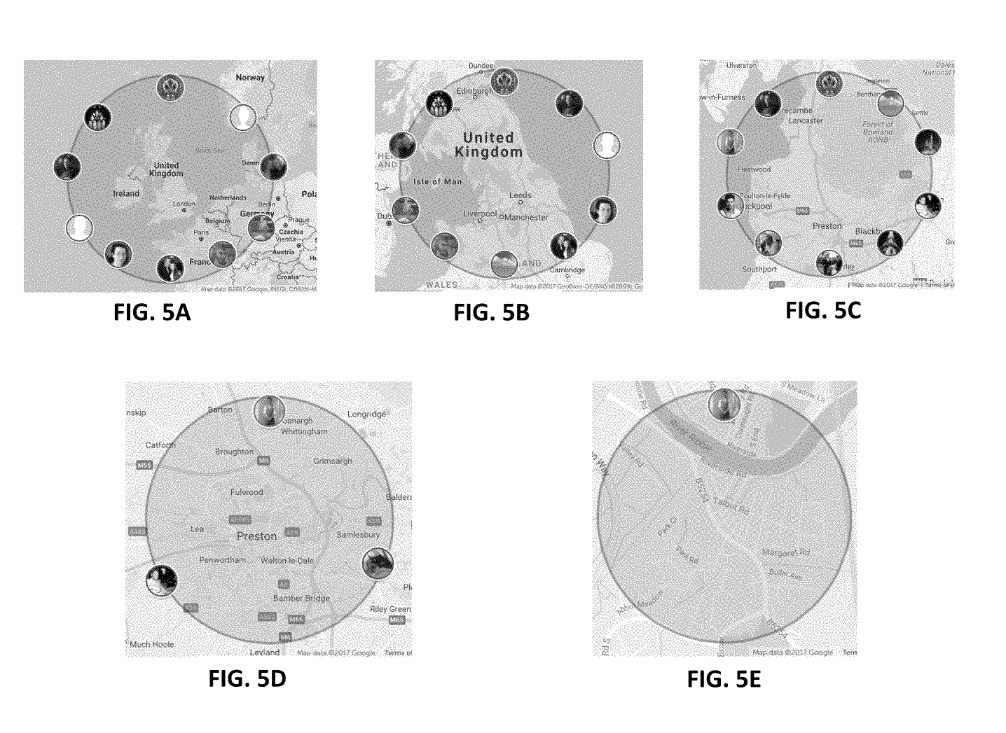

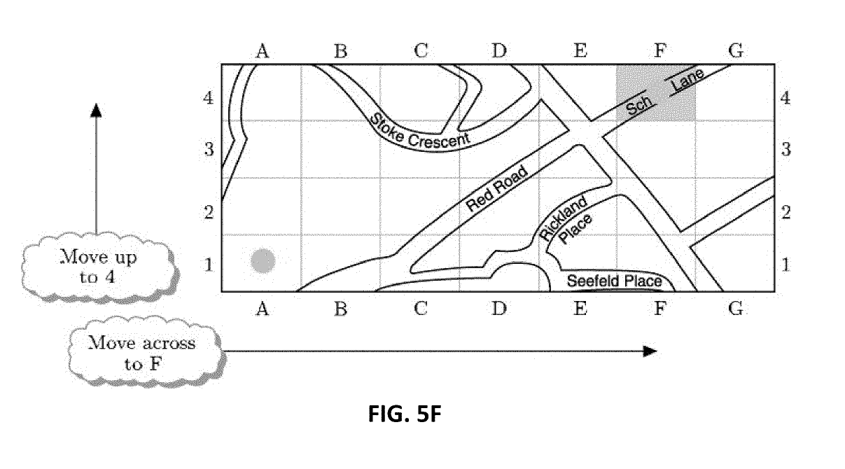

The social media platform (100) of the embodiment allows individuals (200), charitable causes (400), and businesses (300) to register on the platform. The information provided by these entities is maintained in a database (120) that is used in conjunction with the social media platform (100). In addition, ranking information relating to the individuals (200), businesses (300), and charitable causes (400) may be maintained on a database (120) used with the social media platform (100). This ranking information may be presented on the social media platform (100) in the form of lists. Exemplary lists as shown in FIGS. 2B, 3B & 4B include information describing the most generous individuals, the individuals who have inspired the most donations from other users, the charitable causes that have raised the most support, and the businesses that have provided the most support. The social media platform (100) can also display a geographical map that shows the relative charitable activity of individuals (200) within a specific geographical area (see, e.g., FIGS. 5A-5F). This map can be panned and zoomed by the individual (200).

An exemplary presentation of the relative charitable activity in an embodiment is shown in FIGS. 5A-5F. In this embodiment, the social media platform first determines a geographical area of interest, United Kingdom as an example in FIG. 5A, based on various factors, such as the location of the individual user, the business, and/or the charity, the geographical area the user searched last time, the physical location of the platform provider, etc. Social profile pictures or avatars of the top 10 people in the geographical area of interest are shown around a circle on the map, ordered anti-clockwise according to their overall charitable impact to a specific charity/charities or to all charities in this area. That is, the user at the top of the circle in FIG. 5A is the most charitable, followed by the next user on the left of the top position, and so on.

As the map is further zoomed in (see, FIGS. 5B-5D), the users are rearranged—some people in the original top 10 list are excluded and new people in this zoomed-in area are added. When the map reaches a certain zooming level (see, FIG. 5E), fewer than 10 people may remain on the map. Furthermore, when the map is zoomed in to a certain degree, it can become quite easy to identify someone's address, and at this point, anonymity and physical privacy is lost. Therefore, in order to show the charitable activity of users without compromising their privacy, the map shown in the platform of this embodiment preferably adopts an anonymizing method.

The exemplary anonymizing method may include limiting the zoom level of the map so as that it can't be zoomed in to show a single house. For instance, the maximum zoom level/threshold in an embodiment can be limited to a fix number such as 600 m, 1200 m, or 2000 m for the maximum distance in the map. Alternatively, the zoom level in this embodiment may be determined based on a population density or type of the geographical area shown in the map. For instance, the zoom level/threshold in this embodiment can be 500 m in an urban area and 1000 m in a rural area. Moreover, the exemplary anonymizing method may restrict further zooming only when at least one visual presentation remains on the geographical map.

The exemplary anonymizing method may further shift the social profile picture(s) or avatar(s) of the individual user(s) remaining to another location, preferably randomly chosen and different from the real address, on the map when zoom level/threshold is met. FIG. 5F shows an example of such method—when the only remaining user's house is in position A1 in the 7×4 grid on which the map is constructed, the platform randomly chooses to move the user's position to F4 (5 horizontal plus 3 vertical movements). Next time the map is zoom in to show this area, the platform would preferably change the user's position again (not always at F4). Therefore, the user's true address would not be easily known.

In addition, the businesses (300) or charitable causes (400) can include a requirement that a sponsor video be watched prior to contribution activity on the social media platform (100) (see, e.g., steps 341 & 343 in FIG. 3D). This could be expanded to include other interactive activities to reach the contribution activity, such as answering multiple choice questions, taking a quiz, etc. This interaction increases the individual's time becoming aware of the business, and thus, provides a benefit to the business.

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A method for providing recognition of charitable giving on a social media platform comprising the steps of:
providing the social media platform for use on a computer network system wherein at least one individual, at least one charitable cause, and at least one business register information via the social media platform;
providing financial support from the individual to the charitable cause and showing the individual's financial support on the social media platform via a visual representation on the individual's social profile shareable to separate individuals registered with the social media platform;
allowing the at least one individual to view a charitable activity of the separate individuals registered with the social media platform;
allowing the at least one individual to view his charitable activity relative to that of the separate individuals registered with the social media platform;
providing financial support from the at least one business to the at least one charitable cause directed according to the at least one individual;
recognizing the at least one business via a visual recognition of the financial support in the form of a corporate logo superimposed on a logo of the at least one charitable cause on the social media platform;
allowing the at least one charitable cause to maintain a presence on the social media platform and receive financial support from the at least one individual and the at least one business via the social media platform; and
aggregating analytic information about the choices individuals have made and relaying the information to the at least one business and the at least one charitable cause.

2. The method of claim 1, wherein the financial support by the individual to the charitable cause is a gift to a receiving individual.

3. The method of claim 2, wherein the receiving individual is identified by a characteristic of the receiving individual, the characteristic being selected from a group consisting of: demographic factors, geographic location, psychographic factors, and combinations thereof.

4. The method of claim 2, wherein the at least one individual is allowed to give the gift only if an input information is provided by the at least one individual and verified by the business sponsoring the gift, the input information being selected from a group consisting of: a purchase receipt, a promotional code, a QR code, and combinations thereof.

5. The method of claim 1 further comprising the step of increasing an amount of points to an accumulated amount of points saved at the individual's social profile after the individual makes a contribution, wherein the contribution is selected from a group consisting of:
a. making the financial support to the charitable cause;
b. promoting the charitable cause on the social media platform;
c. being identified as an inspiration by another donor;
d. watching a sponsor video; and
e. interacting with a sponsor game.

6. The method of claim 5, wherein the accumulated amount of points is convertible to a fiat currency to be use for a future financial support.

7. The method of claim 1 further comprising the step of rating the charitable cause by the individual and indicating a level of support of the individual to the charitable cause.

8. The method of claim 1 further comprising the step of maintaining rating information about support from the at least one individual, the separate individuals, and the at least one business and received by the at least one charitable cause.

9. The method of claim 8 further comprising the step of automatically presenting the rating information to the individual that made the financial support to the charity cause.

10. The method of claim 8 further comprising the step of presenting the rating information in the form of a geographical map relative to charitable activity of individuals within a specific geographic location.

11. The method of claim 10, wherein the geographical map can be panned and zoomed.

12. The method of claim 11, wherein when the geographical map is zoomed into a predetermined threshold and at least one individual remains on the geographical map:
(i) the geographical map cannot be further zoomed in; and
(ii) if only one individual is still within the geographical map, a visual presentation of the only one individual is randomly shown at a location, other than a residence of the only one individual, on the geographical map.

13. The method of claim 1 further comprising the step of presenting the individual with activities to increase engagement with the social media platform and incentivize charitable support.

14. The method of claim 1 further comprising the step of offering a contribution from the at least one business as a gift available to the at least one individual to direct to charitable causes of choice.

15. The method of claim 14 further comprising the step of requiring a matched donation for the gift provided by the businesses.

16. The method of claim 14, wherein the gift is available to a receiving individual based on a demographic information of the receiving individual.

17. The method of claim 14, wherein the gift is available to a receiving individual based on geographic location of the receiving individual.

18. The method of claim 14, wherein the gift is available to a receiving individual based on psychographic information of the receiving individual.

19. The method of claim 1 further comprising the step of allowing individuals, businesses, and charitable causes to maintain images to act as a representation of identity.

20. The method of claim 1 further comprising the step of promoting individuals, businesses, or charitable causes.

21. The method of claim 1 further comprising the step of the individual providing demographic information via the social media platform.

22. The method of claim 1 further comprising the step of sharing the visual representation of the individual to other social media platforms.

23. The method of claim 1 further comprising the step of requiring the individual to watch a sponsor video associated with the business or charitable cause.

24. The method of claim 1 further comprising the step of requiring an interaction between the individual and the business.

25. The method of claim 1 further comprising the step of aggregating demographic analytic information about the choices individuals have made and relaying the information to the at least one business and the at least one charitable cause.

26. The method of claim 1 further comprising the step of aggregating psychographic analytic information about the choices individuals have made and relaying the information to the at least one business and the at least one charitable cause.

27. A method for showing, on a social media platform, a geographical distribution of charitable giving without compromising donor privacy, the method comprising the steps of:
a. Determining, by a computer, a geographical area of one or more donors as users on the social media platform; and
b. Displaying the geographical area and visual presentations of at least some of the one or more donors residing therein in a predetermined arrangement on a computerized geographical map, the geographical map configured to be pannable and zoomable,
wherein when the geographical map is zoomed into a predetermined threshold and at least one visual presentation remains on the geographical map the geographical map cannot be further zoomed in until the geographical map is zoomed out again.

28. The method in claim 27, wherein when the geographical map is zoomed into the predetermined threshold and only one visual presentation is still shown in the geographical map, the only one visual presentation is randomly displayed at a location, other than a residence of a donor corresponding to the only one visual presentation, on the geographical map.

29. The method in claim 27, wherein the predetermined arrangement is showing visual presentations of a certain number of top donors in the geographical area on a circle with the visual presentations displayed anti-clockwise along a circumference of the circle.

30. The method in claim 27, wherein the predetermined threshold is a radius of geographical area selected from a group of 600 m, 1200 m, and 2000 m, based on a population density of the geographical area.

31. The method of claim 27 further comprising the step of forwarding a gift selected by a user to a receiving individual associated with a charitable cause.

32. The method of claim 31, wherein the receiving individual is identified by a characteristic of the receiving individual, the characteristic being selected from a group consisting of: demographic factors, geographic location, psychographic factors, and combinations thereof.

33. The method of claim 31, wherein the user is allowed to give the gift only if an input information is provided by the user and verified by a business sponsoring the gift, the input information being selected from a group consisting of: a purchase receipt, a promotional code, a QR code, and combinations thereof.

34. The method of claim 27 further comprising the step of increasing an amount of points to an accumulated amount of points saved at a donor's profile after the donor makes a contribution at the social media platform, wherein the contribution is selected from a group consisting of:
a. providing a financial support to a charitable cause;
b. promoting the charitable cause on the social media platform;
c. being identified as an inspiration by another donor;
d. watching a sponsor video; and
e. interacting with a sponsor game.

35. The method of claim 34, wherein the accumulated amount of points is convertible to a fiat currency to be use for a future financial support.

36. The method of claim 27 further comprising the step of visually recognizing a financial support from a donor to a charitable cause by showing a visual representation on the donor's social profile at the social media platform shareable to other users of the social media platform.

37. The method of claim 27 further comprising the step of visually recognizing a financial support from a business to a charitable by showing a corporate logo of the business superimposed on a logo of the charitable cause on the social media platform.
